(19) United States
(12) Patent Application Publication
(10) Pub. No.: US 2025/0060319 A1
(43) Pub. Date: Feb. 20, 2025

(54) Optical Inspection System for Detecting Surface Profile Defects in Manufactured Webs

(71) Applicant: 3M INNOVATIVE PROPERTIES COMPANY, St. Paul, MN (US)

(72) Inventors: Steven P. Floeder, Shoreview, MN (US); Katherine E. Struthers, Minneapolis, MN (US); Taylor E. Hoensheid, Hudson, WI (US); Jeffrey P. Adolf, Rochester, MN (US)

(21) Appl. No.: 18/717,860

(22) PCT Filed: Dec. 13, 2022
(86) PCT No.: PCT/IB2022/062151

§ 371 Date: Jun. 7, 2024

Related U.S. Application Data
(60) Provisional application No. 63/289,933, filed on Dec. 15, 2021.

(51) Int. Cl. G01N 21/89; G01N 21/88; G01N 21/892

(52) U.S. Cl. CPC G01N 21/8903; G01N 21/8806; G01N 21/8851; G01N 21/8921

(57) ABSTRACT

Systems and techniques are described for detecting surface profile defects within a moving web. An example system includes a conveyor configured to translate the web, along a downweb direction and at a translation speed, relative to an inspection area; a point light source configured to emit light, wherein the point light source is positioned and oriented relative to the conveyor to illuminate a portion of the web positioned within the inspection area; a diffusing screen positioned and oriented relative to the conveyor to receive the light reflected from the web as the web is translated through the inspection area; an image capture device configured to capture images of the diffusing screen; and a computing device configured to: identify, based on the images, a surface profile defect in a surface of web; and output data indicating a relative location of the defect within the web.

### TECHNICAL FIELD

The disclosure relates to manufacturing systems and, in particular, inspection systems for optically inspecting sheets or webs of manufactured film.

### BACKGROUND

Manufacturing processes for making various types of films, such as adhesive coated films, involve manufacturing the films in a long continuous sheet, referred to as a web. The web itself is generally a material having a fixed width in one direction (“crossweb direction”) and either a predetermined or indeterminate length in the orthogonal direction (“downweb direction” or “machine direction”) along the manufacturing line.

Surface profile defects, such as dents or surface texture defects, regularly occur in the manufacture of optical films or highly reflective surfaces such as automotive painting applications. Even very subtle or shallow dents can be easily seen by human observers such that the surface quality must be pristine for the product to be acceptable. However, such defects are typically only visible to observers as the object passes in and out of specular reflection, causing appearance of the dent to transition between dark and light. As such, manual inspections are usually performed by manipulating the surface of the web material, so the reflection passes through specular to the observer.

Unfortunately, this is not possible for automated inspection systems and conventional inspection techniques required that the web material be maintained in an extremely flat orientation while being transported through an inspection region so that the imaging can remain near specular reflection. This is sometimes called “near darkfield” or “twilight” lighting. Then, when a surface dent passes through the inspection region, the resultant image shows a bright/dark transition that is easily detected. However, holding the sample in an extremely flat position typically requires a dedicated, offline inspection system such that deflections due to vibration due to movement or due to part curl (flatness) are significantly less than the angular deflection caused by the least severe dent.

### SUMMARY

In general, this disclosure describes techniques for inspecting a web for surface profile defects (e.g., dents, punctures or scratches) using high intensity lighting across the web. In some examples, the techniques utilize collimated lighting across the web, reflecting the light onto a high-performance diffuser screen to produce diffused light, which may be imaged by a precision linescan camera. As a result, as further explained herein, any vibration or curl in the web causes a vertical (z axis) translation of the reflected image on the surface of the diffuser screen without losing focus, and such translation is accommodated in the optical inspection system without impacting the ability to detect transitions from light to dark regions due to surface profile variations of the moving web. This enables subtle dents and other surface profile defects to be detected in high-speed manufacturing environments and overcomes the traditional limitations of web planarity caused by flutter, wrinkling, and other similar causes.

The techniques may be particularly useful for detecting surface defects in optical films during manufacturing operations while the film is transported through a manufacturing system. As additional examples, the techniques may also be useful for detecting distortion lines, also referred to herein as machine direction line (MDL) defects, in a moving web without requiring portions of the web to be sampled and tested in a fixed position, offline inspection system.

In one example, this disclosure describes a system for detecting surface profile defects within a moving web. The system includes a conveyor configured to translate the web in a downweb direction at a translation speed, relative to an inspection area, and a point light source configured to emit light, wherein the point light source is positioned and oriented relative to the conveyor to illuminate, with the light, a portion of the web positioned within the inspection area. The system further includes a diffusing screen positioned and oriented relative to the conveyor to receive the light reflected from the web as the web is translated through the inspection area, an image capture device configured to capture images of the diffusing screen, and a computing device configured to identify, based on the images, a surface profile defect in a surface of web. In some examples, the system generates and output data indicating a relative location of the defect within the web.

In another example, this disclosure describes a method for detecting surface profile defects within a moving web. The method includes translating, by a conveyor of manufacturing process line, a web along a downweb direction and at a translation speed, relative to an inspection area, and emitting, with a point light source, light incident on a surface of the moving web, wherein the point light source is positioned and oriented relative to the conveyor to illuminate a portion of the web positioned within the inspection area. The method further includes receiving, with a diffusing screen positioned and oriented orthogonal relative to the downweb direction of the conveyor, the light reflected from the web as the web is translated through the inspection area, wherein the light reflected from the web forms an on the diffusing screen, the image indicating a shadow of a surface profile defect of the web; generating, with a line scanner image capture device, image data indicative of the image formed on the diffusing screen; and processing, with a processor, the image data to detect the surface profile defect in a surface of web.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating a system for imaging and inspecting a web, such as an optical film, for defects during manufacturing of the web and at line rates of the manufacturing process.

FIG. 2 is a block diagram illustrating further example details of the system of FIG. 1.

FIG. 3 is a cross-sectional view of example web having surface profile defects detectable while the web is moving at manufacturing speeds using the systems and techniques described herein.

FIGS. 4A-4E are images showing example surface profile defects within a web and detectable during manufacturing in accordance with the techniques described herein.

FIG. 5 is a block diagram illustrating in more detail one example implementation of an imaging unit configured for detecting surface profile defects in a moving web.

FIG. 6 is a block diagram illustrating a top-down view of one example implementation of a system configured for detecting surface profile defects in a moving web.

FIG. 7A is a block diagram illustrating a downweb view of one example implementation of an imaging unit configured for detecting machine direction line (MDL) surface profile defects in a moving web in accordance with the techniques described herein.

FIG. 7B is an example image showing example machine direction line (MDL) surface profile defects within the web.

FIG. 8 is a block diagram illustrating an example processing unit of the system of FIG. 1.

FIG. 9 is a flow diagram illustrating an example operation of detecting a defect in a web using a processing unit.

### DETAILED DESCRIPTION

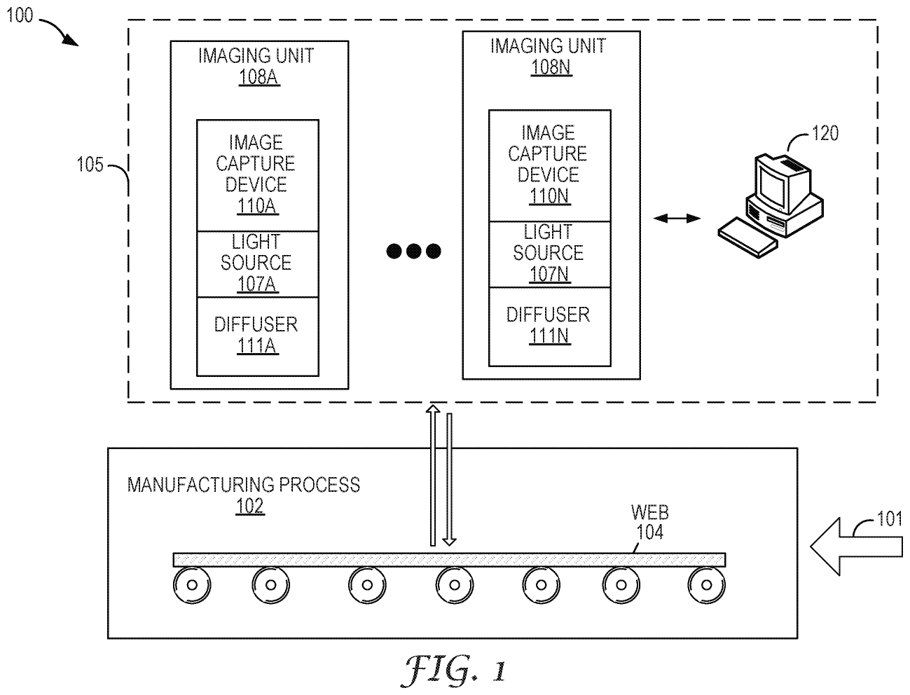

FIG. 1 is a block diagram illustrating a system 100 for manufacturing one or more webs, and for imaging and inspecting the webs for defects. In the example illustrated in FIG. 1, system 100 includes inputs 101, manufacturing process 102 for manufacturing web 104, inspection system 105 and processing unit 120. As further explained, inspection system 105 includes one or more imaging units 108, which each include image capture devices 110A-110N (collectively, “image capture devices 110”), light sources 107A-107N (collectively, “light units 112”) and diffusers 111A-111N, in this example.

In general, manufacturing process 102 receives and/or consists of various inputs 101 (e.g., material, energy, people, machinery) for manufacturing web 104. Manufacturing process 102 is not limited to any particular type or form of manufacturing and is illustrative of any type of manufacturing process operable to produce web 104. Web 104 represents manufactured web material that may be any flexible, web-like material having a fixed dimension in one direction and either a predetermined or indeterminate length in the orthogonal (downweb) direction. Examples of web materials include metals, paper, wovens, non-wovens, glass, polymeric films, flexible circuits, or combinations thereof. Metals may include such materials as steel or aluminum. Wovens generally include various fabrics. Non-wovens include materials (e.g., paper, filter media, or insulating material). Films include, for example, polymer films. The terms “film” and “film product” is used herein to refer to a material formed of a sheet having a nominal thickness, a predetermined width dimension, and a predetermined or indefinite length dimension. In various examples, the film or film product is formed of a single layer of one type of material, the single layer of material being transparent or semi-transparent. However, examples of types of film and film products are not limited to a single layer film or a film comprising just one type of material, and other forms of film are contemplated by use of the terms “film” and “film product” as described in this disclosure.

During the manufacturing process 102, web 104 may accrue a variety of defects. In some examples, defects include surface profile defects, i.e., defects that cause deviations in an outer, generally planar, surface of web 104, such as scratches or dents that project into or protrude from the surface, thereby causing a variation in the three-dimensional (3D) surface profile of the web.

In some scenarios, processing unit 120 is configured to determine whether web 104 includes a defect based on image data captured from web 104 via optical inspection system 105. In general, optically detecting a surface profile deviation of a web material moving at typical line speeds of a manufacturing process, without pausing or halting the processing line, can be challenging due to flutter, curvature, vibrations or other dynamics that lead to unexpected changes in z-axis motion of the surface of a moving web material, especially when a fixed viewing angle and a fixed illumination angle are used in optical inspection system 105. Moreover, such technical challenges can be made even more difficult when inspecting a flexible material, such as web 104, that, unlike a rigid material like glass, may experience surface curvature while being transported within manufacturing process 104. As further described, inspection system 105 provides technical solutions to these technical challenges and enables surface-profile detection of a moving, flexible web 104.

In the example of FIG. 1, each imaging unit 108 of inspection system 105 includes a corresponding light source 107, diffuser 111 and image capture device 110. In general, each light source 107 comprises a point light source configured and arranged to emit either diverging light or collimated light over relatively large regions of web 104, such as regions 200+ or even 3000+ mm across web 104 as the web is transported through manufacturing process 102. As examples, light sources 107 may comprise high-power LEDs, light sources with collimating lenses (optical elements) or even high-intensity, large scale spotlights similar to theater spotlights for generating the collimated light across a width of over a meter of web 104. As one example, light source 107 may include one or more high-power LEDs having model #AFS-700 manufactured by Altman Lighting. Further, in some examples, each light source 107 may be fixed or translated at a particular spatial position or angle relative to web 104 such that each light source 107 emits light on a surface of web 104 at a fixed, single angle of incidence as web 104 is transported through an inspection area associated with inspection system 105. Such a spatial arrangement may be required due to spatial restrictions of manufacturing environments; however, using a single angle of incidence may give rise to technical challenges for detecting surface profile defects in web 104, and such technical challenges may be overcome by the technical solutions described herein.

In some examples, each imaging unit 108 includes a diffuser 111 configured to receive collimated light reflected from the outer surface of web 104. In general, typical diffuse surfaces of web material can be very inefficient in terms of light reflectivity such that reasonably sized defects cannot be detected at common speeds at which web 104 is transported through manufacturing process 102. That is, in typical manufacturing environments, there is often not enough light to sense surface profile defects. To address these issues, in some examples, imaging unit 108 may utilize a diffuser 111, such as a diffuser film, to collect reflected light from web 104 and enable significantly higher signals to be realized from the reflected light. One example advantage of using collimated light is that the collimated light increases tolerance for curvature and motion in the Z direction without loss of focus of the image formed on diffuser 111.

Further, each imaging unit 108 includes an image capture device 110 positioned at a fixed viewing angle relative to the surface of web 104 and configured to receive light reflected by web 104 and generate image data from the reflected light. It is recognized herein that, for detecting surface profile defects in a moving web 104, traditional area cameras are often not effective due to geometry restrictions associated with the optics of area cameras, especially in environments where an area camera may be used at a viewing angle relative to an inspection region, thereby resulting in image amplification or distortion. As such, in some examples, each of image capture devices 110 comprises a high-sensitivity line scan camera or the like that enables higher sensitivity while avoiding the issues that may arise, such as spatial amplification, associated with area cameras positioned at fixed viewing angles to web 104.

Processing unit 120 analyzes the image data produced by imaging unit(s) 108 to identify any surface profile defects. Example techniques include any of the following (or similar) methods of increasing complexity known to those skilled in the art.
Simple blob or connected component analysis,
Pattern matching or “golden template” methods, and
Supervised or unsupervised machine learning using convolutional neural nets.

In some examples, the techniques described herein may be applied to extract surface profile defects even where the surface of web 104 may have a known surface variation, referred to herein as a surface texture. In such cases, processing unit 120 may comprise one or more convolutional neural networks (CNNs) or other machine learning model trained using image data having the known surface variation (e.g., texture or pattern), and may apply the CNNs to identify any surface profile defect within such a surface. For example, in some implementations, processing unit 120 executes one or more inference engines that can use machine learning models to detect and categorize defects in sheet parts using the image data for the sheet part. The machine learning models can define layers of multiple CNNs, where each CNN can be trained to detect a different category of defect based on the image data for the sheet part, and output defect data indicative of defects in the sheet part detected in the image data. Processing unit 120 can use the defect data to determine data indicative of a quality category for the sheet part. For example, processing unit 120 may determine data indicative of a quality category for the sheet part, where the quality category indicates that the sheet part is satisfactory, defective, or needing rework. Processing unit 120 may determine other quality categories in addition to, or instead of satisfactory, defective, or needing rework.

In some aspects, the machine learning model(s) of processing unit 120 can include multiple CNNs trained to detect different type of defects. The inference engine of processing unit 120 can receive image data and pass the image data through the multiple CNNs. The output of each CNN can be data indicating whether the type of defect detected by the CNN is present in the image data. A quality evaluation unit can receive the data indicating whether each type of defect detected by the respective CNNs is present in the image data and apply weight(s) to the data for each defect type to produce data indicating a quality category for the sheet part. Further example details of CNN-based image data analysis for web inspection can be found in U.S. Provisional Patent Application 63/039,065, filed Jun. 15, 2020, entitled “INSPECTING SHEET GOODS USING DEEP LEARNING,” the content of which is hereby incorporated herein by reference.

Further, in some cases, processing unit 120 may process the image data to analyze the surface texture applied to web 104 in addition to detecting any surface profile defects, and such analysis can be configured to generate one or more metrics that provide quantitative information describing or otherwise rating the surface texture for the inspected area. This may be useful for detecting any region within the surface of web 104 that does not satisfy or conform to the desired surface profile or texturing, such a region of the web at which the surface profile has insufficient or too much of a desired “orange peel” surface texture. Example quantitative information characterizing the surface texture at any particular region of the surface of web 104 may include:
One or more metrics from a global statistical analysis (mean, standard deviation, variation, . . . ) of the surface profile of the specific web 104 in the Z direction, or
Data indicative of a frequency analysis generated from the surface profile. For example, the image data could be processed with an FFT or Fast Fourier Transform and the resultant information analyzed to determine dominant frequencies in the image that can be correlated to spatial distances repeating within the product under inspection.

Moreover, processing unit 120 may output an indicator and position information of a defect in the event the quantitative information does not satisfy a threshold amount defined for the desired surface texture and/or does not fall within a range for the desired metric.

As one general example, processing unit 120 may perform blob analysis to determine whether the images of web 104 include any relatively dark areas representing defects having sufficient surface deviation so as to cause a “shadow” on diffuser 111. In one example, processing unit 120 may perform image thresholding and boundary detection to identify dark areas in the image data. For example, processing unit 120 may compare the intensity of each pixel to a threshold intensity and may assign a first value (e.g., a pixel color, such as black) that is indicative of a defect to a pixel of the image when the intensity of that pixel satisfies (e.g., is greater than or equal to) the threshold intensity, and may assign a second value (e.g., white) to the pixel when the intensity does not satisfy (e.g., is less than) the threshold intensity.

In some scenarios, processing unit 120 determines a location of the defect within web 104. For example, processing unit 120 may determine a location in the crossweb direction and the downweb location for each defect detected based on the images. In some examples, processing unit 120 determines a quantity or density of defects within web 104 or within a given portion of web 104.

Processing unit 120 may perform one or more actions in response to determining that web 104 includes one or more surface profile defects. In some examples, the actions include outputting a command that causes manufacturing process 102 to pause or stop manufacturing web 104. In one example, the actions include outputting a notification indicating that web 104 includes a defect. In some instances, the notification also includes data indicating a type and/or a cause of the defect.

Processing unit 120 may output data that assists determining whether to convert web 104 to consumer products (also referred to as consumer-rolls or sheet parts) based on the quantity of defects, density of defects, location of defects, size of defects, or a combination thereof. For example, processing unit 120 may output a recommendation to discard an entire web 104 in response to determining the quantity of defects satisfies (e.g., is greater than or equal to) a threshold quantity. In another example, processing unit 120 may output a recommendation to discard a portion of web 104 in response to determining that the quantity of defects in one portion satisfies the threshold quantity. For example, processing unit 120 may output a recommendation to discard an edge portion of web 104 (e.g., in the crossweb direction) and that the remaining portion of web 104 is suitable for converting to consumer products. In this way, processing unit 120 may selectively convert web 104 or portions of web 104 into consumer-rolls. In some examples, the non-defective or usable webs 104 are converted into consumer-rolls by cutting web 104 into relatively small, individual products (e.g., 5 m, 10 m, or 50 m rolls). As described above, examples of consumer-rolls include packing tape, masking tape, or any other adhesive tape.

In this way, system 100 may automatically detect surface profile defects in one or more webs created by a manufacturing facility. In contrast to examples where a human manually inspects a small portion of the web after the web is manufactured, system 100 may increase the accuracy of detecting surface profile defects by automatically detecting defects within the surface of web 104 at or near manufacturing line rates, i.e. the transport rate of the web during manufacturing, thereby avoiding offline inspections. By more accurately detecting defects in web, and by enabling inline detection of surface profile defects, system 100 may increase an efficiency of the manufacturing facility and increase the quality of webs produced by the manufacturing facility.

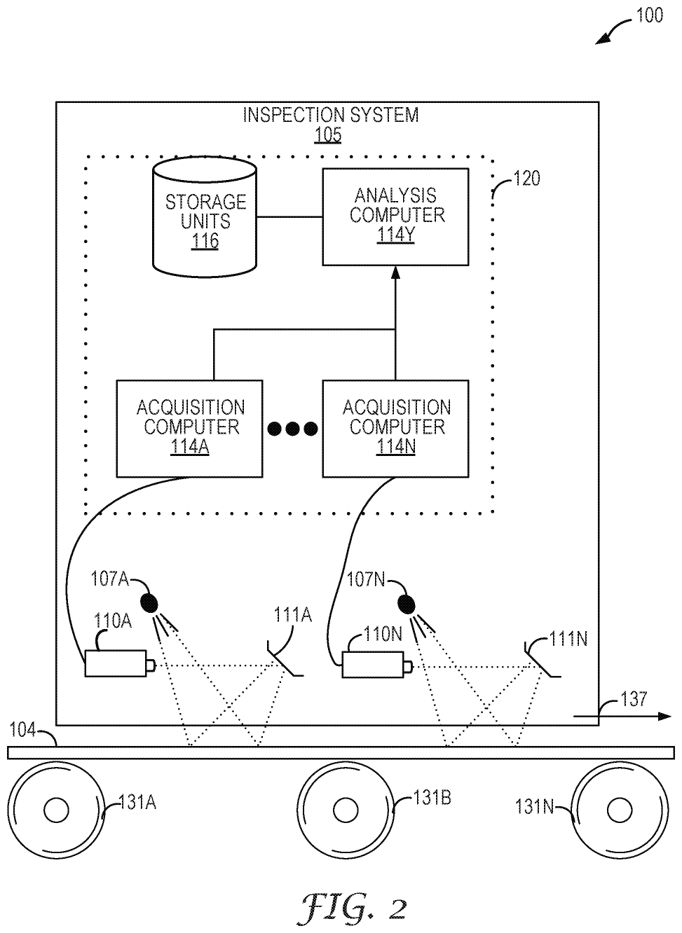

FIG. 2 is a block diagram illustrating another example implementation of system 100 of FIG. 1, in accordance with one or more exemplary implementations and techniques described in this disclosure. As shown in FIG. 2, system 100 includes image capture devices 110, idlers 131A-131N, acquisition computers 114A-114N (collectively, “acquisition computers 114”), analysis computer 114Y, storage units 116, network 118, and processing unit 120.

System 100 includes image capture devices 110A-110N (e.g., line scan cameras) arranged to inspect web 104 by capturing image data from diffusers 111 as the web continuously advance past an inspection area of the image capture devices. In the exemplary embodiment of inspection system 100 as shown in FIG. 2, moving web 104 is transported on idlers 131. Image capture devices 110 are positioned proximate a surface of web 104 so that each of image capture devices 110 may capture image data of web 104 as web 104 advances through imaging unit 108. The number of image capture devices that may be included in image capture devices 110A-110N is not limited to a particular number of devices and may be one, two, or more devices.

As shown in FIG. 2, image capture devices 110 are positioned in proximity to the idlers 131 carrying the plurality of webs. As web 104 moves along idlers 131 in the direction indicated by arrow 137, image capture devices 110 are arranged to image web 104 to obtain image data. During the imaging process that may be performed using system 100, web 104 may advance across idlers 131 in a direction generally indicated by arrow 137.

In general, the systems and techniques described herein provide technical solutions to the technical challenges that arise in inspecting surface profile defects in real-time in manufacturing lines moving at line rates (e.g., from 10 ft/min to 1000 ft/min) where changes to the degree of “flatness” of moving, flexible web 104 can significantly affect the ability to detect surface profile defects. That is, using conventional approaches, web 104 would typically need to be maintained at a particular flatness where any angular deviation due to flutter in Z direction, bagginess on edges, troughing, and the like is less than the minimum detectable angular deviation of a surface profile defect. Typical flatness variations of web 104 on roll-to-roll makers (e.g., idlers 131) could be 0.05 degree to 0.5 degree or more depending on the line precision and product specifics, and visual dent defects visible to human eye via manual inspection can have surface angular deviation of 0.1 degrees, for example. Even inspecting on high-precision idlers or other flat surfaces rather than a free span still give rise to technical challenges since any particles on the roller/surface will “tent” the film (deflect it) in the Z direction. If the film deforms more than a minimum rejectable dent, conventional techniques may lead to a false positive defect due to the tenting, which will repeat at a distance equal to the roll circumference in the event of inspection is performed on an idler. The techniques and systems described herein overcome these technical challenges.

Image capture devices 110 detect light reflected onto one or more diffusers by web 104, as further described below. Image capture devices 110 each provide electrical output signals representative of sensed images of web 104 to a respective set of acquisition computers 114A-114N. Acquisition computers 114A-114N are coupled to analysis computer 114Y and are arranged to provide an output representative of image data captured by the corresponding image capture devices 110A-110N to analysis computer 114Y. In some cases, the acquisition and analysis may occur on the same computer. In other embodiments, image capture devices 110A-110N may provide a digital data stream and/or an analog signal representative of the images captured by the cameras directly to a computing device, such as analysis computer 114Y, for further processing by processing circuitry included in analysis computer 114Y.

In one example, processing circuitry of analysis computer 114Y processes image streams including image data provided from acquisition computers 114A-114N, or in the alternative directly from image capture devices 110A-110N, as web 104 advances through imaging unit 108 on idlers 131. Analysis computer 114Y may also be arranged to output the image data to a database, such as storage units 116 and/or storage units of processing unit 120.

Analysis computer 114Y may be configured to perform one or more pre-processing operations on the images captured by image capture devices 110 before forwarding the images to processing unit 120. Pre-processing of the images may include one or some combination of performing spatial convolutions, ranked filtering (median), contrast enhancement, static flat-field correction, difference of filtered images processing, and/or frequency processing on the image data. Examples of spatial convolutions that may be used to pre-process the image data may include neighborhood averaging, Gaussian kernels gradient filtering, and/or directional edge enhancement. Examples of difference of filtered image processing may include processing based on difference of Gaussians for the image data. Examples of frequency transforms may include processing in frequency space to remove artifacts and then application of an inverse transform.

In general, processing unit 120 may output for display a user interface to provide graphical displays, for example, that are indicative of the results of the analysis of the plurality of sets of reference images. For example, the user interface may indicate whether web 104 includes any defects, including surface profile defects. In one example, the user interface indicates a location, size, shape, cause, and/or type of such defects.

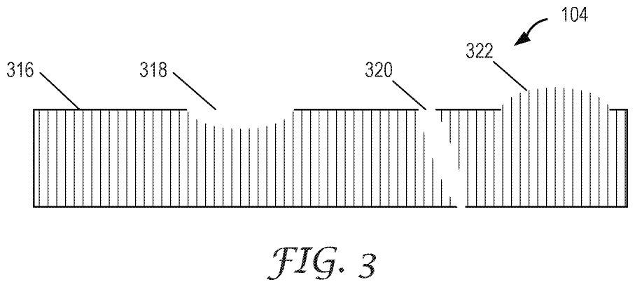

FIG. 3 is a cross-sectional view of example web 104. In one example, web 104 is a multi-layer optical film, such as a display enhancement film that may be applied to increase brightness of backlights used in liquid crystal displays (LCDs). As another example, web 104 may comprise a film that is applied as a paint protection film to automotives without altering the color or design features of the vehicle.

In the example of FIG. 3, web 104 includes an outer surface 316, e.g., a top surface that conforms to a surface profile, such as substantially planar. As shown in FIG. 3, web 104 may comprise surface profile defects were the three-dimensional (3D) profile of surface 316 deviates from the desired profile. In this example, web 104 includes a first defect 318 representing a dent, i.e., a depression within the surface, a second defect 320 representing a tear or puncture and a third defect 322 that represents a protrusion, such as a bump or line, outward from the surface of web 104.

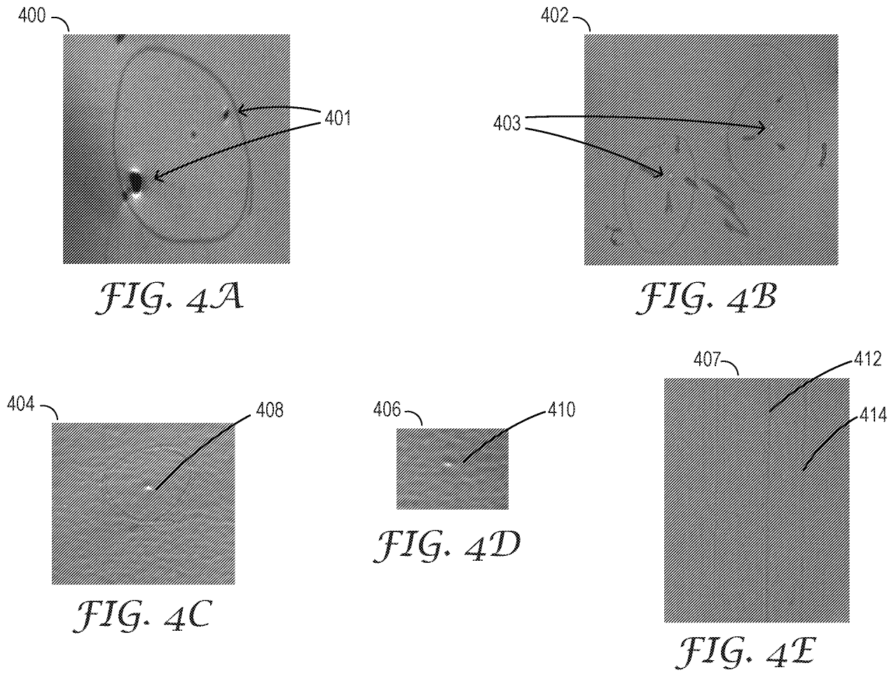

FIGS. 4A-4D are example images showing example surface profile defects within a web. In particular, FIGS. 4A and 4D are images 400, 402, respectively, showing surface profile defects 401 and 403 within optical film having relatively planar surface with little to no desired surface texture, i.e. a “smooth” surface. FIGS. 4C and 4D are images 404, 406, respectively, showing surface profile defects 408 and 410 within optical film used as a protective paint film that conforms to a planar surface having a textured profile, i.e. an “orange peel” surface texture. As described, the techniques and systems disclosed herein enable inline detection of such surface profile defects during manufacturing, i.e., while web 104 is transported through a manufacturing process.

FIG. 4E is an image 407 illustrating surface profile defects 412, 414 referred to as a “machine direction line” (MDL) defects. In various examples, MDL defects are defects in the surface of the film that extend in the downweb (longitudinal axis) direction of the film and often have relatively small dimensions in the crossweb direction, such as in a range of 0.1-10 millimeters. However, the deviation in film thickness in the Z direction or “caliper” for the MDL defects can be extremely small, such as in a range of 100-1000 nanometers. This level of crossweb variation in the film surface is extremely difficult to detect using known film inspection techniques. However, these defects can have significant impact when, for example, web 104 is used as an enhancement film for a display, such as a film used in a computer monitor or a mobile phone, create visually discernable distortion(s) in the display that are noticeable to the human eye when viewing the display or screen. The techniques described herein enable real-time detection of MDL defects during the manufacturing process at line rates for the manufacturing line.

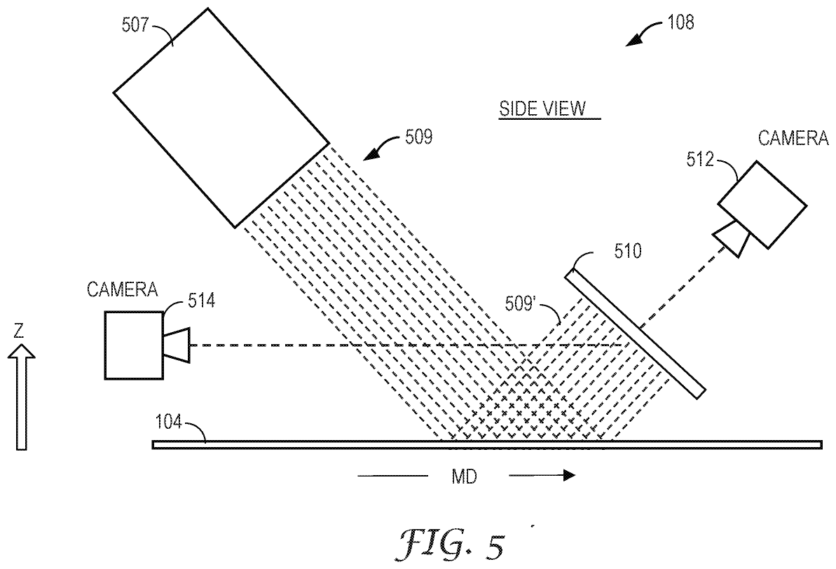

FIG. 5 is a block diagram illustrating in more detail one example implementation of an imaging unit 108 configured for detecting surface profile defects in a moving web 104 while, in some examples, the web is being transported in a downweb (machine) direction (MD) during a manufacturing process. As shown in this example, imaging unit 108 includes a light source 107 that produces light 509 across at least a portion of web 104 in a crossweb direction orthogonal to the MD direction. For example, light source 107 may be a single, point light source that produces diverging light, and may include one or more optical elements, such as mirrors and/or lenses, may be used to collimate the light.

Diffuser screen 510 provides a surface that operates to receive reflected light 509′ reflected from web 104 and to distribute the light at relatively uniform angles of reflection relative to the plane of the diffuser. More specifically, light 509 reflects off a top surface of web 104 as web 104 is transported in the MD direction through the inspection region. Web 104 may conform to a relatively flat profile during transportation; however, the techniques herein enable effective defect detection whenever the surface-profile curvature of the web is much less than the surface-profile deviation for defects of interest, such as dents, scratches and punctures.

In general, light 509′ reflected from web 104, which may be collimated or diverging, forms a shadowgraph image on diffuser screen 510. Typical incident angles of reflected light 509′ can range from 30-75 degrees, for example, from a normal of the surface of web 104 being inspected. On this image, local variations in the reflected surface form “shadows” on diffuser screen 510 that are easily detectable when imaging with a linescan camera 514. By using a linescan camera, even though diffuser screen 510 may be positioned at an angle with respect to web 104, image amplification and depth of field issues otherwise introduced by an area camera can be avoided. As such, the techniques described herein provide the significant technical advantage of providing high tolerance of Z-axis (vertical) motion such as vibration or flutter of web 104 during transport, or even some curvature of the web. That is, any motion in the Z-axis direction simply changes the position of the shadows on diffuser screen 510 and do not affect image fidelity or the ability to detect any shadows within the images that are indicative of surface profile defects within web 104.

In alternative embodiments, diffuser screen 510 operates as a transmissive diffuser configured to allow reflected light 509′ to pass through the screen for emission as diffused, non-collimated light 516. Such a configuration may be advantageous for manufacturing processes and systems in which geometric and spatial constraints would otherwise prevent camera 514 from being position so as to capture images directly from a web-facing side of diffuser screen 510.

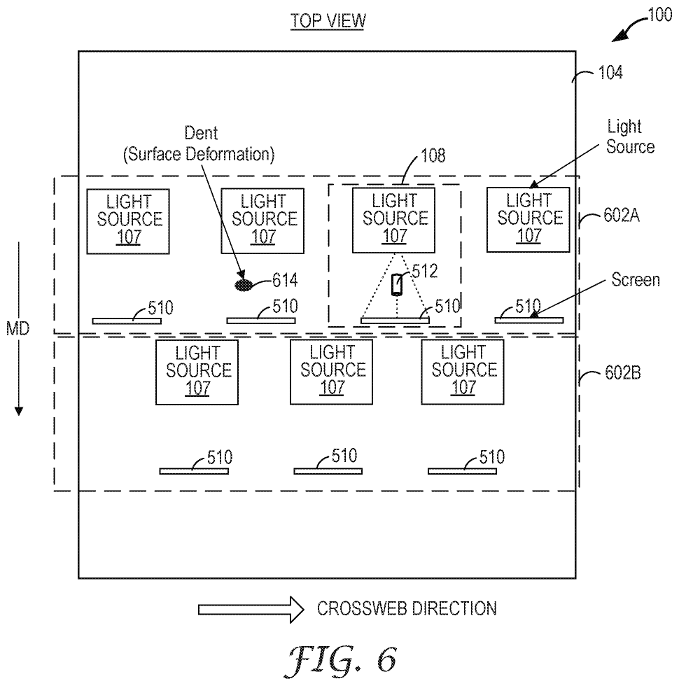

FIG. 6 is a block diagram illustrating a top-down view of one example implementation of system 100 configured for detecting surface profile defects in a moving web 104. As shown in this example, system 100 includes an optical inspection system configured as a plurality of rows 602A, 602B of imaging units 108 spanning web 104 in a crossweb direction. Further, each imaging unit 108 includes: a light source 107 that produces diverging or collimated light across at least a portion of web 104 in a crossweb direction orthogonal to the MD direction; a diffuser screen 510 for collecting collimated, reflected light; and a linescan camera 512 for imaging the shadowgraph formed on the respective diffuser screen 510. For example, each light source 107 may be a single, point light source that produces diverging light, and one or more optical elements, such as mirrors and/or lenses, may be used to collimate the light.

In the example of FIG. 6, imaging units 108 arranged in rows 602A, 602B are staggered in the crossweb direction such that spatial and geometric restrictions of manufacturing environment may be accommodated yet, in aggregate, the entire crossweb width of web 104 is imaged by the image data captured from diffuser screens 510, collectively. That is, each of diffuser screens 510 is of a width W such that the sum of the widths of N diffuser screens is equal to or greater than the entire crossweb width CW of web 104. Moreover, each diffuser screen 510 in row 602A may be positioned to overlap at least a margin amount (e.g., a few centimeters) from corresponding (adjacent in the crossweb direction) diffuser screens 510 in row 602B such that no crossweb gap exists, i.e., no unimaged crossweb area of web 104. Although shown as having two rows of imaging units 108, additional rows may be utilized with diffuser screens 510 having smaller widths, thereby achieving additional room for installing each imaging unit 108 within the manufacturing environment.

One technical advantage of an arrangement like the example shown in FIG. 6 is the reduction in edge effects where light from one light source 107 bleeds into and interferes with an adjacent imaging unit 108. Since imaging units 108 that are adjacent in a crossweb direction are staggered in a downweb direction (i.e., in different rows), the potential for light interference between adjacent imaging units is greatly reduced or eliminated, allowing for higher sensitivity levels to be used. Further, such an arrangement may allow an increased number of high-resolution image capture devices 512 to be positioned within the spatial limitations of a manufacturing process, thus allowing increased resolution for the full, crossweb image data captured from the surface of web 104. In some examples, light sources 107, diffusing screens 510 and image capture devices 512 of the first row 602A are oriented 180 degrees opposite relative to the light sources, diffusing screens and image capture devices of the second row 602B, which may provide certain technical advantages with respect to deploying the image inspection units in spatially limited manufacturing lines.

In general, the techniques described herein for inspection of films in order to detect Machine Direction Line (MDL) surface profile defects in the film. In various examples, MDL defects are defects in the surface of the film that continue in the downweb (longitudinal axis) direction of the film and often have relatively small dimensions in the crossweb direction, such as in a range of 0.1-10 millimeters. Moreover, the deviation in film thickness or caliper for the MDL defects (z direction) can be extremely small, such as in a range of 10-1000 nanometers, making MDL defects very difficult to detect. This level of variation in the film surface is extremely difficult to detect using known film inspection techniques. However, these defects, for example when used as an enhancement film for a display, such as a film used in a computer monitor or a mobile phone, create visually discernable distortion(s) in the display that are noticeable to the human eye when viewing the display or screen. As recognized herein, in order to provide high quality film for use as a film for displays or other uses where minor distortions in the film can be problematic, it is important to be able to detect MDL type of defect in the film before the film is released or sold for use in these applications. Further, as recognized herein, the ability to consistently detect MDL defects can be used to help a film manufacturer locate a source or cause of these MDL defects, and to allow the manufacturing process to be repaired or otherwise adjusted to eliminate the MDL defects in subsequently manufactured webs of film. In addition, as recognized herein the capability to detect MDL defects having variation in the sub-micron range is an effective tool for use in evaluation of the suitability of new raw materials used in the film manufacturing process, and for evaluating process improvements that are being considered for use in the production of films and film products. The example implementations and techniques described herein allow consistent detection of MDL defects causing surface defects in films that have variation in the sub-micron range. These example implementations and techniques also allow for quantitative measures to be made and tracked relative to these MDL defects, thus providing a means for detecting, monitoring, and for making improvements in the manufacturing of these film and film products.

As recognized herein, the MDL defects present in a film change what is referred to as the “optical caliper” of the film along the position of the film where the MDL defect or defects exist. Optical caliper refers to the properties of light waves as the light waves pass through a transparent or semi-transparent film, including the properties of the light waves as the light waves enter the film at a first surface of the film, pass through the film itself, and exit the film at the surface of the film adjacent to the first surface of the film, generally in reference to the thickness dimension of the film. The example implementations and techniques described herein provide imaging of film products and image processing techniques that provide detection and quantification of machine direction lines in the film products that represent sub-micron variations in the film's optical caliper. In various implementations, machine direction lines caused by caliper variations as small as 100 nanometers can be detected using the example implementations and techniques described herein.

As noted above, MDL defects can be problematic. For example, when present on films that are intended for use in display devices such as computer monitors and cellular phones, MDL defects cause distortions to the images being viewed on these display devices that can be distracting to a user. However, due to the very small optical caliper distortion of these MDL defects, conventional techniques, such as measuring the thickness of the film or film product, are not adequate to detect these small dimensional imperfections created by the MDL defects. The example implementations and techniques disclosed herein allow for detection and quantification of MDL defects having sub-micron dimensions.

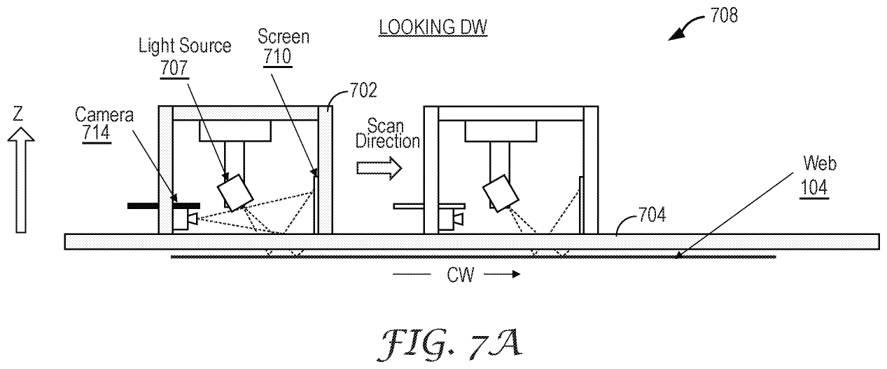

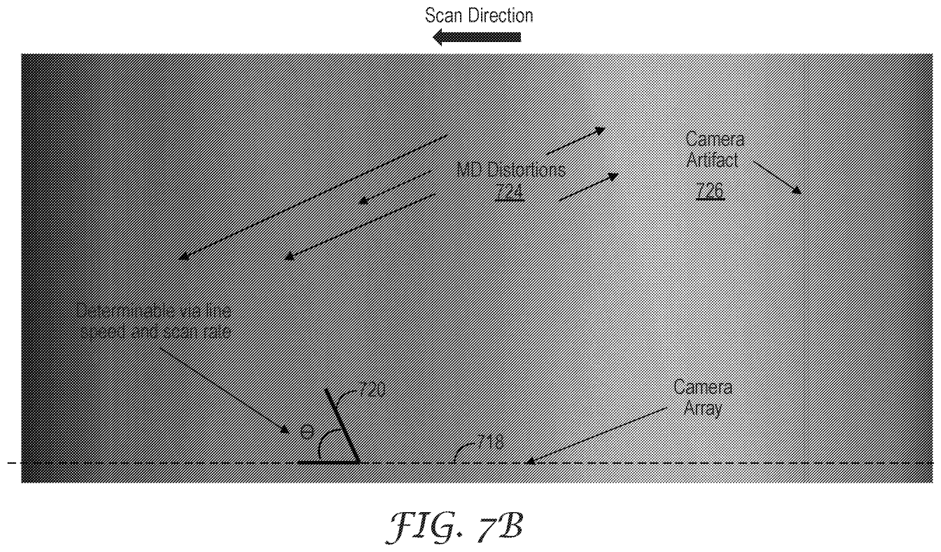

FIG. 7A is a block diagram illustrating a downweb view of one example implementation of an imaging unit 708 configured for detecting machine direction line (MDL) surface profile defects in a moving web 104 while web 104 is being transported at line rates during a manufacturing process. As shown in this example, imaging unit 708 includes a moveable frame 702 positioned on transport support 704. In general, frame 702 housing light source 707, screen 710 and camera 714 of imaging unit 708 is translated in a crossweb direction to scan web 104 as web 104 traverses the manufacturing line.

An MDL defect, also referred to as a distortion line, is typically visible in a continuous or mostly continuous downweb direction. As such, it is recognized herein that directional analysis is useful to increase signal to noise and provide higher accuracy detection and discrimination. Unfortunately, conventional imaging systems often have stationary noise that can be greater than the distortion line signal, i.e., signal to noise is too low. To address this technical challenge, in some examples, frame 702 provides a rigid support for camera 714 and is translated across web 104 to continuously scan web 104 in the crossweb direction while web 104 moves in the downweb direction. Advantageously, as a result of the linear translation in a crossweb direction orthogonal to the direction of movement for web 104, MDL surface-defects will appear as angularly offset within the captured image data, i.e., appear to run at an angle through the imaged area, with such angle being a known function of camera acquisition rate, the web speed and the crossweb scanning rate. As such, a processing unit, such as processing unit 120 of FIG. 1, can be tuned to apply higher sensitivity for detecting linear defects by image processing and filtering the image data according to the known angular offset, thereby eliminating background noise of the sampling system and enabling detection of MDL surface profile defects with much higher precision and sensitivity, which provides significant technical advantages in view of the extremely small variation in surface thickness.

The example imaging unit 708 of FIG. 7A may be especially useful in detection of MDL surface profile defects where extremely small deviations in thickness of web 104 present as nearly undetectable deviations in the surface profile.

In this example, in order to further increase light intensity, rather than outputting collimated light, light source 707 produces diverging light from a single, small point source, expanding out across at least a portion of web 104 in a crossweb direction orthogonal to the MD direction. Diffuser screen 710 provides a surface that operates to receive light reflected from web 104 and to distribute the light at relatively uniform angles of reflection relative to the plane of the diffuser. As described, light reflected from web 104 forms a shadowgraph image on diffuser screen 710.

The following provides an example configuration for imaging unit 708 of FIG. 7A for detecting MDL surface profile defects:
Web speed=60 m/min
Scanning (crossweb) speed=0.6 m/min
Camera acquisition=1K lines/set
Resolution: crossweb set by camera imaging=100 um/pixel; downweb set by web speed and camera acquisition=1 mm/line (a line is the size of the downweb pixel)

At this example configuration, the angle of the distortion line in the film will be zero (directly downweb), but the angle of the distortion line within the image data will be arctan( 1/10)=5.71 degrees. As such, imaging unit 708 and/or the processing unit may be configured to filter the image data at that angle to extract the distortion lines with highest signal to noise ratio (SNR).

FIG. 7B is an image illustrating example machine direction line (MDL) surface profile defects. The techniques described herein enable real-time detection of MDL defects during the manufacturing process at line rates for the manufacturing line. Dashed line 718 represents the camera array of imaging unit 708 that is translated in a scan direction matching the crossweb direction of web 104. Given the known speed at which imaging unit 708 is translated in the crossweb direction relative to the speed at which web 104 is translated in the downweb direction, the processing unit calculates the imaging angle 720. As shown in image 407, MD distortions 724 run at an angle equal to imaging angle 720 within the image data. As such, the processing unit can be tuned to process the image data according to angle 720 to remove noise and separate such objects representing MDL defects from camera artifacts 726, which can be more readily identified since such noise and artifacts do not run at the imaging angle but instead run in a direction orthogonal to camera array 718.

Although described with respect to FIG. 7A by way of example, other examples and embodiments described herein may be used to detect MDL defects, including the example systems of FIG. 5 or 6.

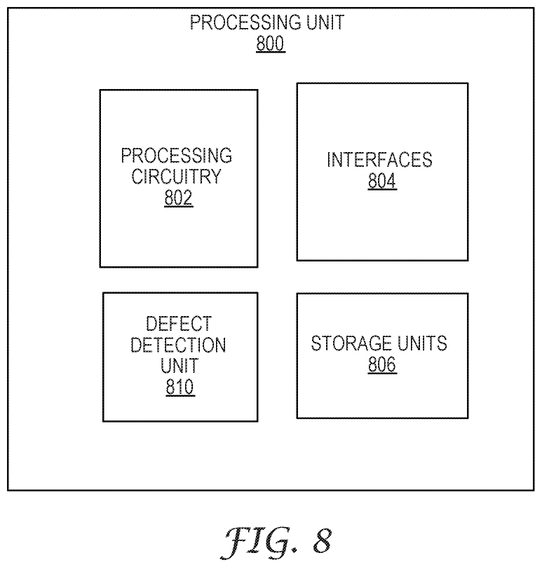

FIG. 8 is a block diagram illustrating an example processing unit 800, in accordance with one or more exemplary implementations and techniques described in this disclosure. Processing unit 800 may be an example or alternative implementation of processing unit 120 of system 100 of FIG. 1. The architecture of processing unit 800 illustrated in FIG. 8 is shown for exemplary purposes only. Processing unit 800 should not be limited to the illustrated example architecture. In other examples, processing unit 800 may be configured in a variety of ways.

Processing unit 800 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, processing unit 800 is electrically coupled to inspection system 105 of FIG. 1. In other examples, processing unit 800 represents a cloud computing system, server farm, and/or server cluster (or portion thereof) configured to connect with system 100 via a wireless connection. In other examples, processing unit 800 may represent or be implemented through one or more virtualized compute instances (e.g., virtual machines, containers) of a data center, cloud computing system, server farm, and/or server cluster. In some examples, processing unit 800 includes one or more computing devices, each of the computing devices having a memory and one or more processors.

As shown in the example of FIG. 8, processing unit 800 includes processing circuitry 802, one or more interfaces 804, and one or more storage units 806. Processing unit 800 also includes a defect detection unit 810, which may be implemented as program instructions and/or data stored in storage units 806 and executable by processing circuitry 802. Storage units 806 of processing unit 800 may also store an operating system (not shown) executable by processing circuitry 802 to control the operation of components of processing unit 800. The components, units or modules of processing unit 800 are coupled (physically, communicatively, and/or operatively) using communication channels for inter-component communications. In some examples, the communication channels include a system bus, a network connection, an inter-process communication data structure, or any other method for communicating data.

Processing circuitry 802, in one example, may include one or more processors that are configured to implement functionality and/or process instructions for execution within processing unit 800. For example, processing circuitry 802 may be capable of processing instructions stored by storage units 806. Processing circuitry 802, may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Processing unit 800 may utilize interfaces 804 to communicate with external systems via one or more networks. In some examples, interfaces 804 include an electrical interface (e.g., at least one of an electrical conductor, a transformer, a resistor, a capacitor, an inductor, or the like) configured to electrically couple processing unit 800 to inspection system 105. In other examples, interfaces 804 may be network interfaces (such as Ethernet interfaces, optical transceivers, radio frequency (RF) transceivers, Wi-Fi or Bluetooth radios, or the like), telephony interfaces, or any other type of devices that can send and receive information. In some examples, processing unit 800 utilizes interfaces 804 to wirelessly communicate with external systems, e.g., inspection system 105 of FIG. 1.

Storage units 806 may be configured to store information within processing unit 800 during operation. Storage units 806 may include a computer-readable storage medium or computer-readable storage device. In some examples, storage units 806 include one or more of a short-term memory or a long-term memory. Storage units 806 may include, for example, random access memories (RAM), dynamic random access memories (DRAM), static random access memories (SRAM), magnetic discs, optical discs, flash memories, magnetic discs, optical discs, flash memories, or forms of electrically programmable memories (EPROM) or electrically erasable and programmable memories (EEPROM). In some examples, storage units 806 are used to store program instructions for execution by processing circuitry 802. Storage units 806 may be used by software or applications running on processing unit 800 to temporarily store information during program execution.

In some examples, defect detection unit 810 is configured to automatically detect defects in one or more layers of a web, such as web 104. For example, defect detection unit 810 may detect whether web 104 includes a defect as described above. In one example, defect detection unit 810 detects that web 104 includes a defect and determines a position of the defect within web 104. In some examples, defect detection unit 810 determines a type of a defect and/or a cause of the defect, as described above.

As described, processing unit 800 may perform one or more actions in response to determining that web 104 includes a defect. In one example, the action includes outputting a notification indicating that web 104 includes a defect. In some instances, the notification also includes data indicating a type of the defect, a cause of the defect, a location of the defect, a size of the defect, or a combination thereof.

In some examples, the action includes outputting a command that causes a manufacturing process, such as manufacturing process 102 of FIG. 1, to pause or stop manufacturing web 104. In another example, the action includes outputting a command causing a manufacturing element of the manufacturing process 102 to adjust a process parameter for the manufacturing process. In another example, the action includes generating a defect map or other data structure that identifies the positions of any detected defect and that can be used to control converting of the web into part components.

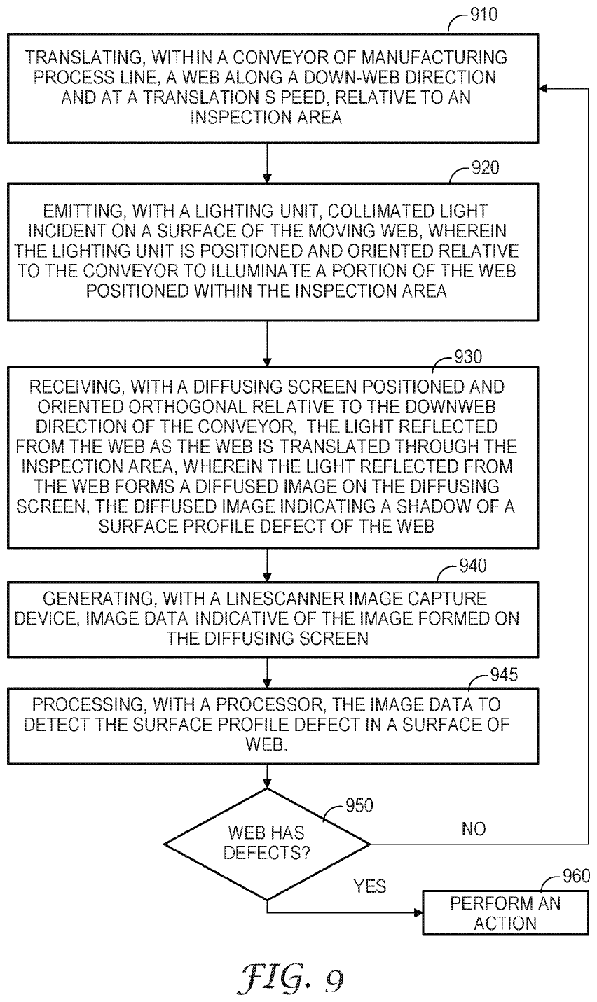

FIG. 9 is a flow diagram illustrating example operation of system 100 for detecting surface profile defects within a moving web, in accordance with one or more techniques of this disclosure. As seen in the example of FIG. 9, manufacturing process 102 initially may translate, within a conveyor of manufacturing process line, a web 104 along a downweb direction and at a translation speed, relative to an inspection area (910). Next, a light source 107 may emit collimated light incident on a surface of the moving web 104, wherein the light source is positioned and oriented relative to the conveyor to illuminate a portion of the web positioned within the inspection area (920). Next, a diffusing screen, positioned and oriented orthogonal relative to the downweb direction of the conveyor (e.g., diffuser screen 510), may receive the light reflected from web 104 as web 104 is translated through the inspection area, wherein the light reflected from web 104 forms an image on the diffusing screen, wherein the image includes an image region forming a shadow of a surface profile defect of the web (930). Next, a linescan camera (e.g., any of cameras 110, 512, 514) may scan the diffusing screen to generate image data indicative of the image formed on the diffusing screen (940). Next, a processor (e.g., a hardware-based processor of processing unit 120) may process the image data to detect the surface profile defect in a surface of web (945).

Responsive to determining that web 104 includes a defect (“YES” branch of 950), processing unit 120 performs at least one action (960). In one example, the action includes outputting a notification indicating that web 104 includes a defect. In some scenarios, the action includes outputting a command that adjust the manufacturing process 102. For example, the command may cause manufacturing process 102 to pause or stop manufacturing web 104. In another example, the command records the spatial position of the defect on web 104 for controlling conversion of web 104 into part components such that the portion of web 104 having the defect is not included in the part components.

Responsive to determining that web 104 does not include a defect (“NO” branch of 950), inspection system 105 continues automatically inspecting webs 104 in accordance with the techniques described herein.

The techniques described in this disclosure may be implemented, at least in part, in hardware, software, firmware or any combination thereof. For example, various aspects of the described techniques may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a non-transitory computer-readable medium or computer-readable storage medium, containing instructions. Instructions embedded or encoded in a computer-readable medium may cause a programmable processor, or other processor, to perform the method, e.g., when the instructions are executed. Computer readable storage media may include RAM, read only memory (ROM), programmable read only memory (PROM), EPROM, EEPROM, flash memory, a hard disk, a CD-ROM, a floppy disk, a cassette, magnetic media, optical media, or other computer-readable storage media. The term “computer-readable storage media” refers to physical storage media, and not signals or carrier waves, although the term “computer-readable media” may include transient media such as signals, in addition to physical storage media.

Various examples have been described. These and other examples are within the scope of the following claims.

What is claimed is:

1. A system for detecting surface profile defects within a moving web, the system comprising:
a conveyor configured to translate the web, along a downweb direction and at a translation speed, relative to an inspection area;
a point light source configured to emit light, wherein the point light source is positioned and oriented relative to the conveyor to illuminate a portion of the web positioned within the inspection area;
a diffusing screen positioned and oriented relative to the conveyor to receive the light reflected from the web as the web is translated through the inspection area;
an image capture device configured to capture image data indicative of an image formed on the diffusing screen; and
a computing device configured to:
identify, based on the image data, a surface profile defect in a surface of the web; and
output data indicating a relative location of the defect within the web.

2. (canceled)

3. (canceled)

4. The system of claim 3, wherein the threshold variation in the defect comprises a deviation of at least about 0.05 degrees.

5. The system of claim 1,
wherein the surface of the web is constructed to conform to a surface pattern, and
wherein the computing device is further configured to analyze the image data to generate quantitative information describing a texture of the surface, and
wherein the computing device is configured to, based on the quantitative information, detect the surface profile defect as an area where the surface of the web deviates at least a threshold amount from the surface pattern.

6. The system of claim 1, wherein the image capture device comprises a line-scan camera defining a scanning array oriented perpendicular to the downweb direction.

7. The system of claim 1, wherein the light from the point light source comprises divergent light.

8. The system of claim 7 further comprising one or more optical elements to control emitted light angles ranging from fully divergent to slightly converging.

9. The system of claim 1, wherein the point light source comprises a light emitting diode (LED) or a spotlight configured to output collimated light in a crossweb region of the web having a width of at least 1 meter.

10. The system of claim 1, wherein the image capture device is configured to capture the image data at a resolution that is higher than a scale associated with image distortion resulting from a vibrational motion of the system.

11. The system of claim 1, wherein the diffusing screen comprises a diffuse reflective screen oriented to reflect the collimated light toward the image capture device.

12. The system of claim 1, wherein the diffusing screen comprises a diffuse-light transmission screen.

13. The system claim 1,
wherein the point light source, the diffusing screen and the image capture device form one of a plurality of imaging units, each of the imaging units comprising a point light source arranged to illuminate a crossweb portion of the surface of the web with collimated light, a diffusing screen arranged to receive the collimated light reflected from the web and a line scanner camera arranged to image the diffusing screen,
wherein the plurality of imaging units are arranged in a plurality of rows across the web, and wherein the plurality of imaging units are staggered in a crossweb direction to form a staggered pattern so that each of the diffusing screens collects collimated light from a different crossweb portion of the web.

14. The system of claim 13, wherein the staggered pattern comprises a first row of point light sources, diffusing screens, and image capture devices, and a second row of point light sources, diffusing screens, and image capture devices, and wherein the point light sources, diffusing screens and image capture devices of the first row is oriented 180 degrees opposite relative to the point light sources, diffusing screens and image capture devices of the second row.

15. The system of claim 1, wherein the computing device comprises a machine-learning model trained to identify the defect in the web based on the image data.

16. The system of claim 1, wherein the web comprises a polyester film, an optical film or a protective automotive paint film.

17. The system of claim 1, wherein the translation speed of the web during inspection comprises about 10 ft/minute to about 1000 ft/minute.

18. The system ofclaim 1,
wherein the surface profile defect in the web comprises a machine direction line (MDL) defect that is approximately parallel with the downweb direction, and
wherein the MDL defect has a variation in a thickness of the web in a range of 10-1000 nanometers.

19. The system of claim 18, further comprising a frame for translating the image capture device in a crossweb direction while the web is translated in the downweb direction, and wherein the computing device is configured to identify the MDL defect by:
determining an imaging angle based on a speed at which the scanner is translated and a speed at which the web is translated; and
identifying defects within the image data that are approximately parallel to the imaging angle.

20. A method for detecting surface profile defects within a moving web, the method comprising:
translating, within a conveyor of manufacturing process line, a web along a downweb direction and at a translation speed, relative to an inspection area;
emitting, with a point light source, light incident on a surface of the moving web, wherein the point light source is positioned and oriented relative to the conveyor to illuminate a portion of the web positioned within the inspection area;
receiving, with a diffusing screen positioned and oriented orthogonal relative to the downweb direction of the conveyor, the light reflected from the web as the web is translated through the inspection area, wherein the light reflected from the web forms an image on the diffusing screen, the image indicating a shadow of a surface profile defect of the web;
generating, with a linescanner image capture device, image data indicative of the image formed on the diffusing screen; and
processing, with a processor, the image data to detect the surface profile defect in a surface of web.

21. The method of claim 20, further comprising outputting, with the processor, data indicating a relative location of the defect within the web.

22. The method of claim 20, further comprising transmitting the light emitted by the point light source through an optical element to collimate the light for illuminating the portion of the web.
